(19) United States
(12) Patent Application Publication
(10) Pub. No.: US 2007/0192641 A1
(43) Pub. Date: Aug. 16, 2007

(54) Method and apparatus to manage power consumption in a computer

(75) Inventors: Gururaj Nagendra, Shrewsbury, MA (US); Priya Vaidya, Shrewsbury, MA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Intel Corporation

(21) Appl. No.: 11/351,373

(22) Filed: Feb. 10, 2006

(51) Int. Cl. G06F 1/26; G06F 1/32

(52) U.S. Cl. 713/320

(57) ABSTRACT

A method and apparatus to manage power consumption in a computer have been presented. In one embodiment, the method includes registering one or more applications with a power management module in a computer, the one or more applications being operable on a virtual machine in the computer. The method may further include learning usage and behavior of the one or more applications at runtime and dynamically changing power consumption in the computer in response to at least one of the usage and the performance of the one or more applications.

### TECHNICAL FIELD

Embodiments of the invention relate generally to computers, and more particularly, to managing power consumption in a computer.

### BACKGROUND

Processors are semiconductor chips designed for use in computers, which may include mobile computing devices (such as cellular telephones, personal digital assistants, etc.). With increasing frequency and memory size, the voltage consumption by processors is also increasing. Thus, power consumption by processors is also increasing. With new processor platform features being in almost every new generation of processors, power consumption in computers is rising rapidly. However, the supply of power to computers, such as from a battery, may be limited. As a result, solutions to conserve power in computers are in great demand.

In many conventional computers, virtual machines are commonly used to run programs and to provide virtual machine services, such as Garbage Collection. A virtual machine is self-contained logical module that behaves as if it is a separate computer. Programs that run on the virtual machine in a computer are commonly referred to as managed runtime mobile applications. Contrary to the managed runtime mobile applications, programs operable on computers without using virtual machine services are commonly referred to as “native applications.” The operating environment in which the managed runtime mobile applications run on the virtual machine is referred to as a managed runtime environment (MRTE). Some examples of MRTE include Java2 Mobile Environment (J2ME) and Microsoft® NET® Compact Framework (.NETCF). In the current document, managed runtime mobile applications and virtual machine services are collectively referred to as “the applications.”

Typically, the applications increase power consumption overheads in many conventional computers. For example, J2ME-based three-dimensional (3D) graphics games and multimedia players are currently some of the most popular usage models that consume significant amount of power. Newer applications having multimedia usage models, such as video processing, motion camera applications, data processing applications, and security intensive mobile commerce applications are going to further increase power consumption overheads in coming years.

Currently, in a conventional Java runtime environment, Java virtual machine services, such as Just in Time (JIT) compiler, garbage collection (GC), Interpreter, etc., and certain common Java applications, like multimedia applications, contribute towards significant portions of power consumption. With the demand for Java applications on computers rising, power consumption on computers is going to grow rapidly.

Conventional techniques to conserve power in a MRTE include analyzing power consumption per instruction during the compile time of some applications. For example, the power spent to execute the instructions at an opcode level in the MRTE may be estimated in order to formulate a power management policy. However, these existing techniques fail to address situations unforeseeable during the compile time, such as automatic code generation at runtime (i.e., the period of time in which the application is being executed). Hence, these conventional techniques fail to provide a comprehensive power management policy for computers.

### BRIEF DESCRIPTION OF THE DRAWINGS

Embodiments of the present invention is illustrated by way of example and not limitation in the figures of the accompanying drawings, in which like references indicate similar elements and in which:

FIG. 1A shows one embodiment of a functional architecture of a processing module in a computer;

FIG. 1B shows the duty cycle behavior of one embodiment of an application;

FIGS. 2A-2B show some embodiments of a process to manage power consumption in a computer; and

FIG. 3 shows one embodiment of a computer.

### DETAILED DESCRIPTION

A method and apparatus to manage power consumption in a computer are disclosed. In the following detailed description, numerous specific details are set forth in order to provide a thorough understanding. However, it will be apparent to one of ordinary skill in the art that these specific details need not be used to practice some embodiments of the present invention. In other circumstances, well-known structures, materials, circuits, processes, and interfaces have not been shown or described in detail in order not to unnecessarily obscure the description.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

A computer that supports multiple frequency and voltage steppings may include a power management module. Since frequency is directly related to voltage, and hence, frequency is directly related to power as well. Thus, the lower the frequency, the lower the voltage and the lower the power. To conserve power, the power management module may learn or gain knowledge of the usage and behavior of one or more applications running on a virtual machine in the computer at runtime and may dynamically change power consumption in the computer in response to the usage and behavior learnt. More details of various embodiments of the above operations are described below.

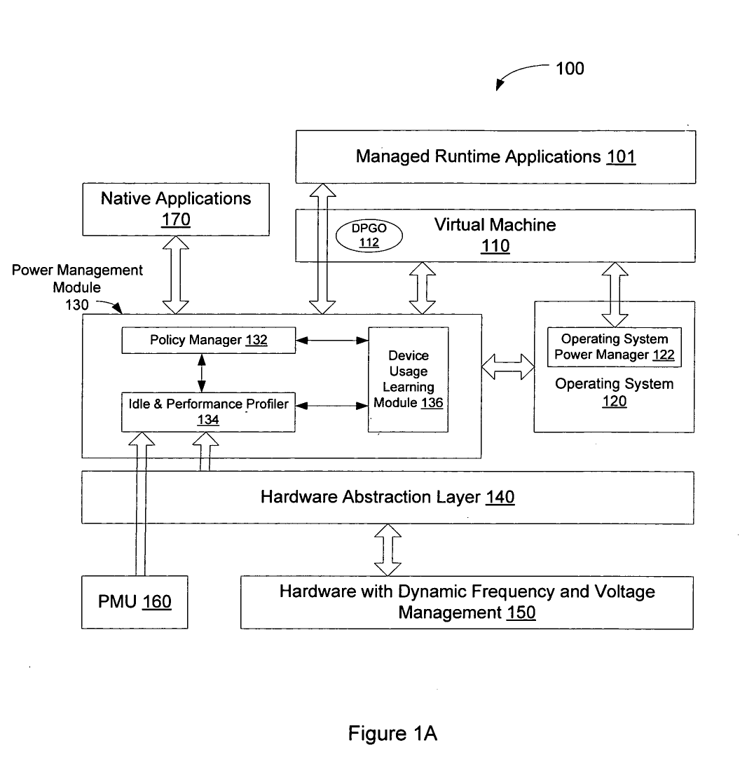

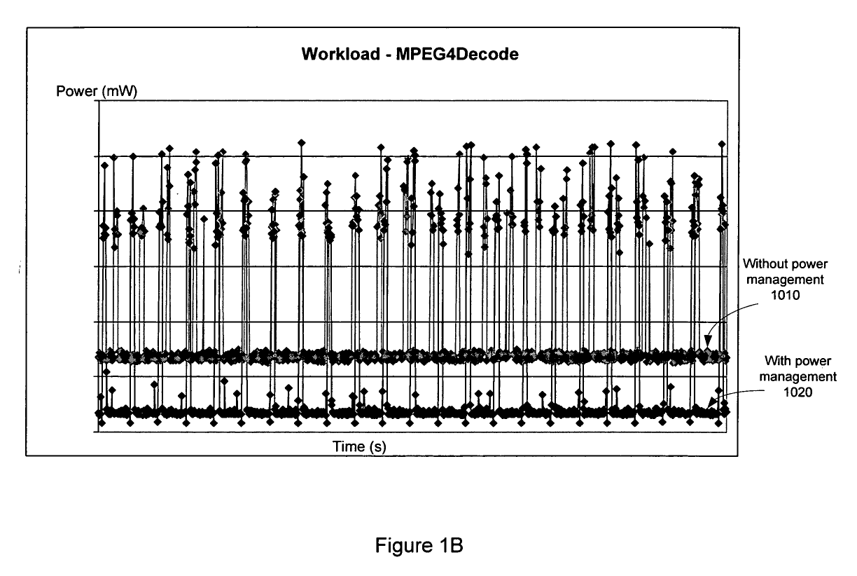

FIG. 1 shows one embodiment of a functional architecture of a system in a computer. The system 100 includes applications 101, a virtual machine 110 (e.g., a Java Virtual Machine, a Microsoft® .NETCF, etc.), an operating system 120, a power management module 130, native applications 170, a hardware abstraction layer 140, a Performance Monitoring Unit (PMU) 160, and hardware 150 with dynamic frequency and voltage management. The hardware 150 supports multiple frequency and voltage steppings. In other words, the hardware 150 may operate at a number of frequencies and a number of voltages The hardware 150 interfaces with the hardware abstraction layer 140, which may include one or more driver application programming interfaces (APIs). The hardware abstraction layer 140 and the PMU 160 are coupled to the power management module 130, which is further coupled to the native applications 170, the virtual machine 110, the managed runtime applications 101, and the operating system 120.

The virtual machine 110 may include a dynamic profile guided optimization (DPGO) module 112, which is a realtime performance sampling tool. The power management module 130 includes a policy manager 132, an idle and performance profiler 134 (hereinafter, “the profiler”), and a device usage learning module 136. The operating system 120 may include an operating system power manager 122.

Note that any or all of the components and the associated hardware illustrated in FIG. 1 may be used in various embodiments of the system 100. However, it should be appreciated that other configurations of the system may include more or less devices than those shown in FIG. 1.

The power management module 130 may provide a generic software solution framework that uses a system-level approach and works closely with the embedded operating system power manager 122 in the operating system 120. A system level perspective allows the power management module 130 to understand the resource demand by the core and other system components and fine tune the core, peripheral, memory and/or interconnect frequency individually. An operating system and application independent solution allows further power management policy adaptation based on the system usage.

The applications 101 may include managed runtime applications (e.g., video playback applications, games, etc.) and virtual machine services (e.g., Garbage Collection, JIT compiler, etc.). The applications 101 may register with the power management module 130. For example, the power management module 130 may include a registration module to register the applications 101. To register with the power management module 130, the applications 101 may send information about themselves to the power management module 130, such as application type (e.g., audio, video, etc.), application state (e.g., running, waiting, etc.), etc. Furthermore, the power management module 130 may un-register an application based on a pre-defined setting such that the application is excluded from being monitored by the power management module 130. The power management module 130 may also configure itself based on some user defined settings, such as performance headroom, system configurations based on pre-defined frequency steppings, etc.

During runtime of the applications 101, the power management module 130 may monitor the applications 101 to learn or to gain knowledge of the usage and behavior of the applications 101. Furthermore, the power management module 130 may also learn or gain knowledge of the usage and behavior of the native applications 170. To learn the usage and behavior, the power management module 130 may perform various tasks to collect information about the usage and behavior of the applications 101 and/or the native applications 170 and to analyze the information. For instance, the power management module 130 may sample the usage of the applications 101 to determine how often the applications 101 are run, for how long the applications 101 are executed, the way the applications are executed, etc.

As mentioned above, the power management module 130 may include the device usage learning module 136, the profiler 134, and the policy manager 132. In some embodiments, the profiler 134 is responsible for probing the system 100, collecting the statistics on the power usage of various components within the system 100, and making the statistics available to the policy manager 132 and the device usage learning module 136. The profiler 134 may use the PMU 160 to generate the statistics about a load of a central processing unit in the computer and a memory load. The policy manager 134 may use the statistics to determine a system operating point, which may include a core frequency, bus and/or memory frequencies, and a processor state. Then the hardware 150 may run at the new system operating point. The hardware 150 may interact with the policy manager 134 using the driver application programming interfaces (APIs) in the hardware abstraction layer 140.

In some embodiments, the applications 101 include a streaming application that plays Motion Picture Experts Group 4 (MPEG4) video and/or MPEG layer-3 (MP3) audio data. The streaming application registers with the profiler 134, which collects statistics on the power usage of the streaming application. The profiler 134 feeds the statistics collected into the policy manager 132. Using the statistics from the profiler 134, the policy manager 132 makes optimal frequency selection for smooth running of the streaming application. FIG. 1B shows the duty-cycle behavior of one embodiment of the streaming application. The curve 1010 indicates the power consumption of the streaming application running on one system 100 without using the power management module 130. The curve 1020 indicates the power consumption of the streaming application running on one system 100 using the power management module 130.

The device usage learning module 136 learns the usage of the applications 101 during runtime. Then the device usage learning module 136 sends information about the usage pattern to the policy manager 132 to dynamically adjust the power policy based on the usage pattern. Although usage models and frequency of application usages typically vary between users, the device usage learning module 136 may nevertheless generate a power conservation heuristic based on a user's usage characteristics.

The virtual machine 110 may further include a realtime performance sampling tool, such as the dynamic profile guided optimization (DPGO) module 112. Using the DPGO module 112, the power management module 130 monitors the performance of the applications 101. The power management module 130 may adjust the power consumption policy in the computer accordingly in order to reduce the impact of power consumption on the performance of the applications 101. For example, if the power supply to the system 100 falls below a certain threshold level, the power management module 130 may lower the frequency to allow only the highest priority applications to run. The priority of the applications may be determined during configuration of the system 100. Alternatively, the priority may be preset according to a default configuration. For virtual machine services, such as GC, the power management module 130 may control the operating point frequency. For example, if GC has to run at a higher frequency than the current operating point frequency level, the power management module 130 checks if the GC can be suspended and re-scheduled in a future cycle in which the operating point frequency level is increased.

The power management module 130 may transparently throttle one or more frequencies of the computer up and/or down to conserve power without impeding on the performance of the applications running. To throttle a frequency of the computer, the power management module 130 adjusts the frequency up and/or down until a predetermined effect is achieved, such as causing the performance of an application to meet a predetermined threshold. The DPGO module 112 may monitor the performance of the applications 101. The power management module 130 may throttle the frequencies without impeding the performance of the applications 101. For example, the power management module 130 lowers the frequency to conserve power in the computer. However, the power management module 130 may raise the frequency when performance of the applications 101 falls below a certain threshold. Therefore, in the perspective of the applications 101, the frequencies are throttled transparently.

The power management module 130 may determine the appropriate system operating point based on the pattern of the power usage. Thus, the operating point may be optimized for the determined pattern. Alternatively, the power management module 130 may switch to an appropriate frequency stepping based on a sampled load of various components within the computer, such asa processor, a memory, etc. For instance, the power management module 130 may switch to a lower frequency stepping if the sampled load is higher than a predetermined threshold. Likewise, the power management module 130 may switch to a higher frequency stepping if the sampled load is lower than a predetermined threshold.

The power management module 130 may monitor the execution progress of the applications 101 to smooth up and/or down transitions of the frequency stepping in the system 100 based on various factors, such as the usage pattern, priority, and/or frequency mappings. As such, the voltage level at which the applications 101 and/or virtual machine services are run at may be adjusted dynamically to optimize the power consumption in the computer. For instance, if the applications 101 and virtual machine services are constantly running at higher frequencies, the power management module 130 investigates several possibilities to lower the frequency stepping. The power management module 130 may ping the DPGO module 112 to determine the performance hotspots at runtime and causes a compiler in the computer to recompile one or more of the applications 101 corresponding to the performance hotspots at a higher level of optimization. Alternatively, the power management module 130 may link the one or more of the applications 101 corresponding to the performance hotspots with some available optimized library functions.

Based on the usage of the various applications 101, the power management module 130 may smartly and dynamically cause applications with a higher priority to adjust their operations when the power supply is below a predetermined threshold as well as shutting down applications with a lower priority. Alternatively, the applications with a lower priority may be forced to reduce their performance or quality in order to reduce power consumption when the power supply falls below a predetermined threshold. For example, the power management module 130 may cause a video display application to reduce the resolution of the video frames. In another example, the power management module 130 may cause an audio streaming application to turn down the volume. In a further example, the power management module 130 may shut off the audio portion of an audio plus video streaming application.

One or more of the applications 101 may dynamically generate code at runtime. The power usage of such dynamically generated code may not be accurately determined or estimated at compile time of the applications 101 because such code has not yet been generated at the compile time. However, the device usage learning module 136 may detect the execution of the dynamically generated code and determine the power usage of such code. Based on the power usage determined, the policy manager 132 may adapt the power policy accordingly to optimize the overall power usage of the applications 101.

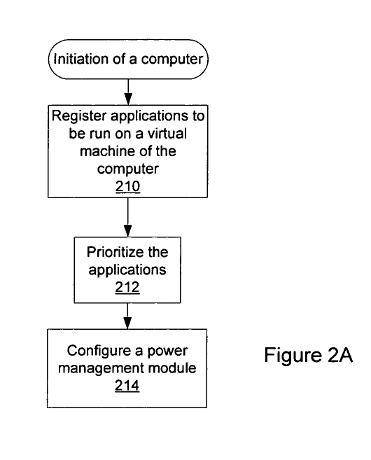

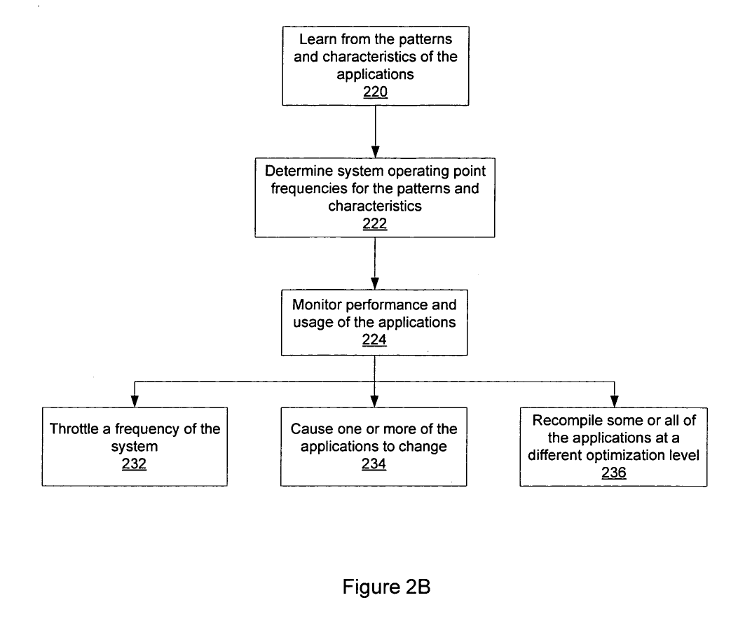

Some embodiments of a process to manage power consumption in a computer are described in details below with reference to FIGS. 2A-2B. The process may be performed by processing logic that may comprise hardware (e.g., circuitry, dedicated logic, etc.), software (such as a program operable to run on a general-purpose computer system or a dedicated machine), firmware, or a combination of any of the above. In some embodiments, the computer includes a general-purpose mobile computing device (e.g., a portable computer, etc.). Alternatively, the computer includes a portable computing device for specific applications (e.g., a personal digital assistant, a cellular telephone, etc.).

Referring to FIG. 2A, the process begins when the computer is initialized. Processing logic registers applications to be run on a virtual machine of the computer (processing block 210). The applications may include managed runtime applications (e.g., multimedia games, audio streaming, etc.) and/or virtual machine services (e.g., Garbage Collection, JIT compiler, etc.). Then processing logic may prioritize the registered applications and/or virtual machine services (processing block 212). The priority may be set based on information received during registration of the applications, default configuration of the computer, and/or predefined settings from a user of the computer. For example, a voice application may have a higher priority than a display application to operate a display device (e.g., a liquid crystal display (LCD)) in the computer and media applications. Based on the priority of the registered applications, processing logic configures a power management module in the computer (processing block 214).

When the computer is in use, processing logic may perform the operations illustrated in FIG. 2B to manage power consumption in the computer. Processing logic learns the usage and behavior of the applications registered (processing block 220). Processing logic may determine a system operating point of the computer based on the usage and behavior of the applications (processing block 222). The system operating point may include a core frequency, bus and/or memory frequencies, and a processor state.

Processing logic may monitor the performance and usage of the applications (processing block 224). For example, processing logic may sample the loads of the applications periodically. Based on the performance and/or usage, processing logic may perform various tasks to optimize power consumption in the computer. For example, processing logic may throttle a frequency (e.g., a core frequency, a interconnect/memory frequency, etc.) in the computer (processing block 232). Alternatively, processing logic may cause one or more of the applications to change their operations to conserve power when the power to the computer falls below a predetermined threshold (processing block 234). For instance, processing logic may send a signal to a video plus audio streaming application to cause the application to reduce the resolution of the video in order to reduce the power consumption of the application. For applications of lower priority, processing logic may send a signal to cause these applications to shut down when the power to the computer falls below the predetermined threshold. For instance, a voice application in a cellular telephone may have a higher priority than a LCD application and media applications. Thus, when power falls below a predetermined threshold, processing logic may cause the LCD application and the media applications to shut down when while leaving the voice application on. In one embodiment, processing logic recompiles some or all of the applications at a different optimization level (processing block 236). Alternatively, processing logic may link a hotspot functionality of the applications with one or more optimized library functions.

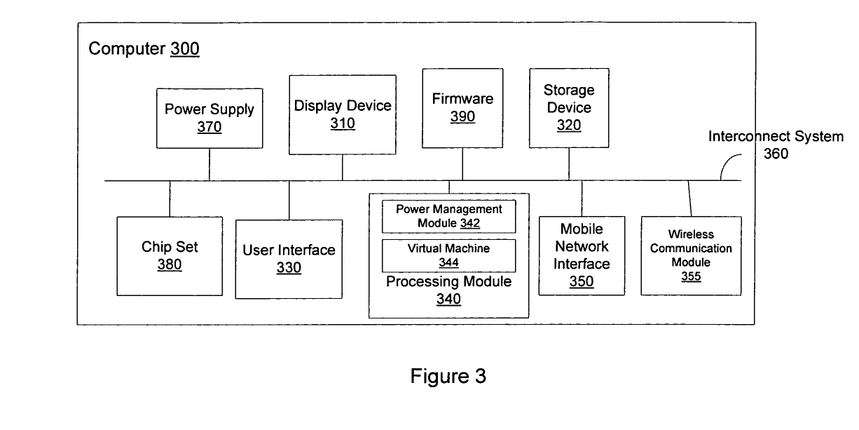

FIG. 3 shows one embodiment of a computer. In some embodiments, the computer is a general-purpose mobile computing device (e.g., a portable computer, etc.). Alternatively, the computer is a portable computing device for specific applications (e.g., a personal digital assistant, a cellular telephone, etc.). The computer 300 includes a display device 310, a storage device 320, a user interface 330, a processing module 340, a mobile network interface 350, a wireless communication module 355, an interconnect system 360, a power supply 370, and a chip set 380. The interconnect system 360 includes interconnects (e.g., busses, cables, wires, etc.) to couple the display device 310, the storage device 320, the user interface 330, the processing module 340, the mobile network interface 350, the wireless communication module 355, the power supply 370, and the chip set 380 to each other. The mobile network interface 350 may communicably couple to a mobile network (e.g., a Global System for Mobile Communication (GSM) network, a Code Division Multiple Access (CDMA) network, etc.) via the mobile network interface 350. Note that the mobile network may include wireless networks and wire lined networks. The wireless communication module 355 may employ a Wireless Application Protocol to establish a wireless communication channel. The wireless communication module 355 may implement a wireless networking standard such as Institute of Electrical and Electronics Engineers (IEEE) 802.11 standard, IEEE std. 802.11-1999, published by IEEE in 1999.

The storage device 320 may include a random access memory (RAM) or other dynamic storage device (referred to as main memory) for storing information and instructions to be executed by the processing module 340. The storage device 320 also may be used for storing temporary variables or other intermediate information during execution of instructions by the processing module 340. In some embodiments, the storage device 320 may include static storage device (e.g., read only memory (ROM)) and/or non-volatile memories (e.g., flash memory) to store data and/or instructions to be executed by the processing module 340. The static storage device and/or non-volatile memories may store operating system level and application level software.

Firmware 390 may be a combination of software and hardware, such as Electronically Programmable Read-Only Memory (EPROM) that has the operations for the routine recorded on the EPROM. The firmware 390 may embed foundation code, basic input/output system code (BIOS), or other similar code. The firmware 390 may make it possible for the computer 300 to boot itself.

The display device 310 may be implemented with various components, such as a cathode ray tube (CRT), a liquid crystal display (LCD), or other similar components.

The user interface 330 may include various user interface mechanism and/or devices, such as alphanumeric keys, soft keys, a cursor control device (e.g., a mouse, trackball, trackpad, stylus, cursor direction keys, etc.), special purpose keys (e.g., menu key, disconnect key, etc.), etc.

In addition to the power supply 370, which may include one or more batteries, the computer 300 may include an Alternating Current (AC) adapter circuit to power the computer using an AC supply external to the computer 300.

Note that any or all of the components and the associated hardware illustrated in FIG. 3 may be used in various embodiments of the computer 300. However, it should be appreciated that other configurations of the computer may include one or more additional devices not shown in FIG. 3.

The processing module 340 may include a power management module 342. Furthermore, the processing module 340 includes a virtual machine 344, on which applications are run. The applications may include various managed runtime applications (e.g., multimedia games, audio and video streaming applications, etc.) and/or virtual machine services (e.g., Garbage College, JIT compiler, etc.). The power consumption by the applications is profiled and dynamically optimized at runtime by the power management module 342. For instance, the power management module 342 may learn the usage and behavior of applications. Based on the usage and the behavior of the applications, the power management module 342 may cause the applications to optimize power consumption at runtime in response to the level of available power supply. Details of some embodiments of the power management process and some embodiments of the functional architecture of the processing module 340 have been described above.

Some portions of the preceding detailed description have been presented in terms of symbolic representations of operations on data bits within a computer memory. These descriptions and representations are the tools used by those skilled in the data processing arts to most effectively convey the substance of their work to others skilled in the art. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

An apparatus may perform the operations described herein. This apparatus may be specially constructed for the required purposes, or it may comprise a general-purpose computer selectively activated or reconfigured by a computer program stored in the computer. Such a computer program may be stored in a machine-accessible storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will appear from the description below. In addition, embodiments of the present invention are not described with reference to any particular programming language. It will be appreciated that a variety of programming languages may be used to implement the teachings as described herein.

The foregoing discussion merely describes some exemplary embodiments of the present invention. One skilled in the art will readily recognize from such discussion, the accompanying drawings and the claims that various modifications can be made without departing from the spirit and scope of the subject matter.

What is claimed is:

1. A method comprising:
registering one or more applications with a power management module in a computer, the one or more applications being operable on a virtual machine in the computer;
learning usage and behavior of the one or more applications at runtime; and
dynamically changing power consumption in the computer in response to at least one of the usage and the performance of the one or more applications.

2. The method of claim 1, further comprising:
prioritizing the one or more applications based on information received from the one or more applications during the registering; and
configuring the power management module based on information from the one or more applications and one or more predetermined settings.

3. The method of claim 1, wherein dynamically changing power consumption in the computer comprises throttling a frequency of the computer in response to the usage of the one or more applications.

4. The method of claim 1, wherein learning the usage of the one or more applications comprises:
sampling the usage of the one or more applications; and
determining a usage pattern for each of the one or more applications based on data from the sampling of the usage of the one or more applications.

5. The method of claim 4, wherein learning the behavior of the one or more applications further comprises:
detecting code dynamically generated at runtime by the one or more applications; and
determining power consumption by execution of the dynamically generated code.

6. The method of claim 1, further comprising learning usage and behavior of at least one native application operable in the computer at runtime.

7. A machine-accessible medium that provides instructions that, if executed by a processor, will cause the machine to perform operations comprising:
registering one or more applications with a power management module in a computer, the one or more applications being operable on a virtual machine in the computer;
learning usage and behavior of the one or more applications at runtime; and
dynamically changing power consumption in the computer in response to at least one of the usage and the performance of the one or more applications.

8. The machine-accessible medium of claim 7, wherein the operations further comprise:
prioritizing the one or more applications based on information received from the one or more applications during the registering; and
configuring the power management module based on information from the one or more applications and one or more predetermined settings.

9. The machine-accessible medium of claim 7, wherein dynamically changing power consumption in the computer comprises:
causing at least one of the one or more applications to change in response to a power level of a power supply to the computer crossing a predetermined threshold.

10. The machine-accessible medium of claim 7, wherein learning the usage of one or more applications comprises:
sampling the usage of the one or more applications; and
determining a usage pattern for each of the one or more applications based on data from the sampling of the usage of the one or more applications.

11. An apparatus comprising:
a virtual machine on which one or more applications run; and
a power management module coupled to the virtual machine to dynamically adjust power consumption of the one or more applications during runtime of the one or more applications based on at least one of a usage and a performance of the one or more applications.

12. The apparatus of claim 11, further comprising:
a performance monitoring unit to monitor the performance of the one or more applications.

13. The apparatus of claim 12, wherein the power optimization module further comprises:
a profiler coupled to the device usage learning module to generate statistics on the usage of the one or more applications, wherein the device usage learning module determines the usage of the one or more applications based on the statistics from the profiler; and
a policy manager coupled to the profiler to determine an operating point based on the statistics from the profiler.

14. The apparatus of claim 11, wherein the virtual machine comprises a dynamic profile guided optimization module to monitor the performance of the one or more applications.

15. The apparatus of claim 11, wherein the power management module is operable to throttle a frequency at which the virtual machine operates based on at least one of the usage and the performance of the one or more applications.

16. The apparatus of claim 11, wherein the power management module further comprises a registration module to register the one or more applications.

17. The apparatus of claim 16, further comprising:
a device usage learning module to learn the usage and the behavior of the one or more applications at runtime.

18. The apparatus of claim 17, wherein the device usage learning module is operable to sample the usage of the one or more applications.

19. The apparatus of claim 16, wherein the one or more applications include at least a media application and a voice application and the registration module is operable to assign a first priority to the voice application and a second priority to the media application, the first priority being higher than the second priority.

20. A system comprising:
a display device; and
a processing module coupled to the display device, the processing module comprising
a virtual machine on which one or more applications run; and
a power management module coupled to the virtual machine to dynamically adjust power consumption of the one or more applications during runtime of the one or more applications based on at least one of a usage and a performance of the one or more applications.

21. The system of claim 20, wherein the power optimization module comprises a device usage learning module to sample the usage of the one or more applications.

22. The system of claim 20, wherein the virtual machine comprises a dynamic profile guided optimization module to monitor the performance of the one or more applications.

23. The system of claim 20, further comprising a power supply coupled to the processing module, wherein the one or more applications include a video display application to display video frames on the display device and the power management module is operable to cause the video display application to change a resolution of the video frames in response to a power level of the power supply crossing a predetermined threshold.

24. The system of claim 20, further comprising a mobile network interface to couple to a mobile network.
